(19) United States
(12) Patent Application Publication
(10) Pub. No.: US 2014/0193705 A1
(43) Pub. Date: Jul. 10, 2014

(54) BATTERY CELL

(71) Applicant: Samsung SDI Co., Ltd., Yongin-si (KR)

(72) Inventor: Jae-Wook Lee, Yongin-si (KR)

(73) Assignee: Samsung SDI Co., Ltd., Yongin-si (KR)

(21) Appl. No.: 14/097,577

(22) Filed: Dec. 5, 2013

(30) Foreign Application Priority Data
Jan. 10, 2013 (KR) 10-2013-0003041

(51) Int. Cl. H01M 2/02

(52) U.S. Cl. CPC H01M 2/0217
USPC 429/179

(57) ABSTRACT

In one aspect, a battery cell including a case, an electrode assembly and a top portion where the case has an opened first surface and at least one region including resin is provided.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0003041, filed on Jan. 10, 2013, in the Korean Intellectual Property Office, the entire content of which is incorporated herein by reference.

### BACKGROUND

1. Field

This disclosure relates to a battery cell.

2. Description of the Related Technology

Recently, secondary batteries have been used as power sources of portable electronic devices. Demand for a secondary battery as an energy source is increasing sharply as demand for portable electronic devices increases. Secondary batteries can be charged/discharged a plurality of times, and accordingly are economically and environmentally advantageous.

Small size and light weight of electronic devices are crucial, thus, small size and light weight of secondary batteries are also crucial. However, the small size and light weight of the secondary battery is limited due to the safety of a secondary battery since a material such as lithium having high reactivity is included in the secondary battery. Accordingly, a variety of studies have been conducted to develop a battery cell that can be implemented as a small and light battery cell while improving the safety of the secondary battery.

### SUMMARY

Embodiments provide a battery cell having improved safety while being small in size and light in weight by employing a new member.

Embodiments also provide a battery cell which can be easily manufactured by simplifying the structure thereof.

Some embodiments provide a battery cell including: a case having an first surface; an electrode assembly accommodated in the case; and a top portion positioned on the first surface, and to which a terminal portion extended from the electrode assembly is exposed, wherein the case has at least one region including resin. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

In some embodiments, the top portion may include resin.

In some embodiments, the case may include a first region formed on a second surface opposite to the first surface; and a second region formed at a side surface connecting the first and second surfaces to each other. In the case, the second region may include resin.

In some embodiments, the top portion and the second region may be formed in a single body.

In some embodiments, the top portion and the second region may be thermally bonded to each other.

In some embodiments, the first region may include metal.

In some embodiments, the first region may include aluminum or magnesium.

In some embodiments, the inner surface of the first region opposite to the electrode assembly may be anodized.

In some embodiments, the battery cell may further include an insulation sheet positioned on the inner surface of the first region opposite to the electrode assembly.

In some embodiments, the top portion and the second region of the case may be injection-molded.

In some embodiments, at least one of a first connection portion of the first region and a second connection portion of the second region, by which the first and second regions are connected to each other, may be bent.

In some embodiments, at least one of a first connection portion of the first region and a second connection portion of the second region, by which the first and second regions are connected to each other, may be formed to be stepped.

In some embodiments, the outermost surface of the portion at which the first and second regions are connected to each other may form the same plane as the outer surface of the second region.

In some embodiments, the outermost surface of the portion at which the first and second regions are connected to each other may enter further inward than the outer surface of the second region.

Other features and advantages of the present embodiments will become more fully apparent from the following detailed description, taken in conjunction with the accompanying drawings.

Terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

In some embodiments, the top portion and the second region of the case are made of resin, so that it is possible to decrease the weight of the battery cell and to improve the safety of the battery cell. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

In some embodiments, the top portion and the second region of the case are manufactured through injection molding, so that the structure of the battery cell can be simplified. Accordingly, the manufacturing process of the battery cell can be easily performed.

In some embodiments, the portion at which the first and second regions of the case are connected to each other is formed to be stepped, thereby implementing the miniaturization of the battery cell. In some embodiments, the first region and the second region comprise a connection region. In some embodiments, the connection region comprises a first overlapping segment and a second overlapping segment, wherein the first overlapping segment has a first surface and a second surface, and the second overlapping segment has a first surface and a second surface. In some embodiments, the outside surface of the side comprises the first surface of the first overlapping portion. In some embodiments, the second surface of the first overlapping portion is on the first surface of the second overlapping segment. In some embodiments, the second surface of the second overlapping segment is on the first surface of the first overlapping segment. In some embodiments, the outside surface of the side does not comprise the first overlapping segment.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a perspective view of a battery cell according to an embodiment of the present invention.

FIG. 2 is an exploded perspective view of the battery cell shown in FIG. 1.

FIG. 3 is a sectional view of the battery cell shown in FIG. 1.

FIGS. 4 and 5 are sectional views of battery cells according to other embodiments of the present invention.

FIG. 6 is a sectional view of a battery cell according to still another embodiment of the present invention.

### DETAILED DESCRIPTION

In the following detailed description, only certain exemplary embodiments have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

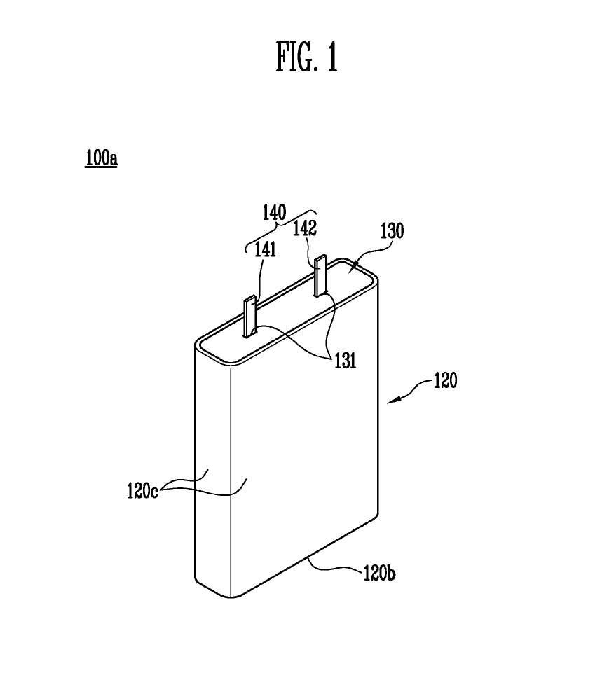

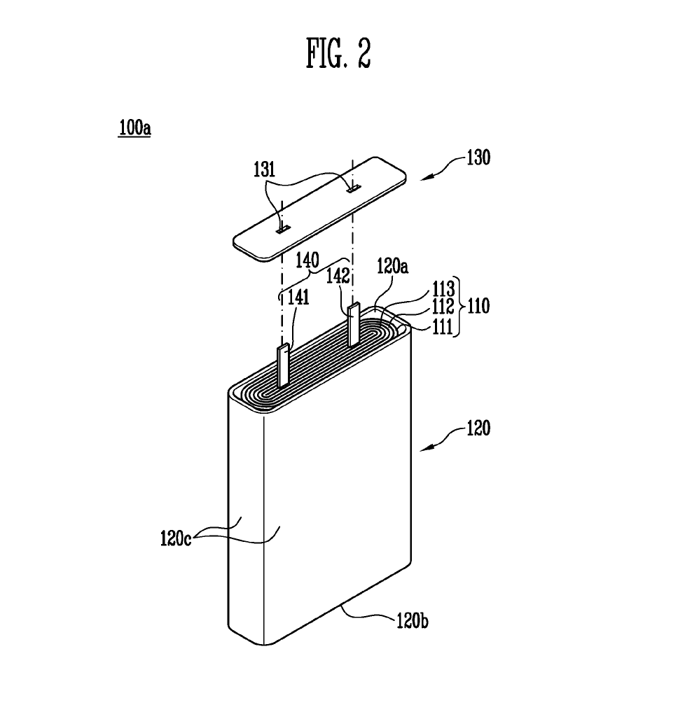

FIG. 1 is a perspective view of a battery cell 100a according to an embodiment. FIG. 2 is an exploded perspective view of the battery cell 100a shown in FIG. 1. Hereinafter, the battery cell 100a according to this embodiment will be described with reference to FIGS. 1 and 2.

As shown in FIGS. 1 and 2, the battery cell 100a according to this embodiment may include an electrode assembly 110, a case 120 accommodating the electrode assembly 110 therein, a top portion 130 positioned on an first surface 120a of the case 120, and a terminal portion 140 extended to the outside from the top portion 130. FIG. 1 provides a view of the battery cell 100a in a disassembled state where the top portion 130 is shown removed to view electrode assembly 110. The top portion 130 forms the first surface 120a of the battery cell 100a in a assembled state.

The electrode assembly 110 is a member that generates electrochemical energy through the movement of ions or electrons.

In some embodiments, the electrode assembly 110 may be formed by winding a positive electrode plate 111, a negative electrode plate 113 and a separator 112 interposed therebetween. In some embodiments, the positive and negative electrode plates 111 and 113 may be manufactured by coating slurries on aluminum and copper metal foils and drying the coated slurries, respectively. In some embodiments, the slurry may include a fixing agent that allows an active material of each of the positive and negative electrode plates 111 and 113 to be adhered to the metal foil. In case of a lithium secondary battery, an oxide containing lithium may be mainly used as a positive electrode active material, and any one of hard carbon, soft carbon, graphite and carbon material may be mainly used as a negative electrode active material. However, the present embodiments are not limited to the lithium secondary battery.

The case 120 is a member that accommodates the electrode assembly 110 through the first surface 120a.

In some embodiments, the case 120 accommodates the electrode assembly 110 through the first surface 120a, so as to protect the electrode assembly 110 from an external impact. In some embodiments, an electrolyte may be accommodated, together with the electrode assembly 110, inside the case 120. In some embodiments, the horizontal section of the case 120 may be implemented to have a rectangular shape having rounded corners. However, the shape of the horizontal section of the case 120 is not limited thereto and may be implemented as a rectangular or elliptical shape. In some embodiments, the case 120 may be implemented as a prismatic or cylindrical case.

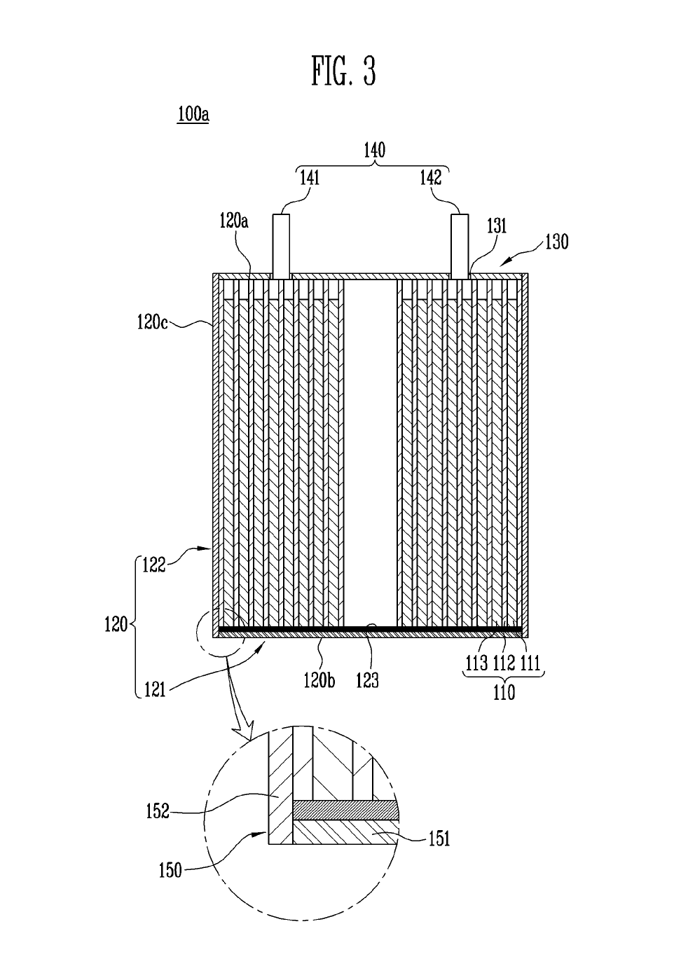

FIG. 3 is a sectional view of the battery cell 100a shown in FIG. 1. Hereinafter, the case 120, the top portion 130 and the terminal portion 140 according to this embodiment will be described in detail with reference to FIG. 3.

In some embodiments, the case may include a first region 121 and a second region 122. In some embodiments, the first region 121 and the second region 122 include a connection region 150. In some embodiments, the first region 121 may include metal and the second region 122 may include resin. In some embodiments, the connection region 150 includes a first overlapping segment 152 and a second overlapping segment 151, wherein the first overlapping segment 152 has a first surface and a second surface, and the second overlapping segment 151 has a first surface, a second surface and a side surface. In some embodiments, the first surface of the first overlapping segment 152 contacts the side surface of the second overlapping segment 151. In some embodiments, the first region 121 may be formed on a second surface 120b opposite to the first surface 120a of the case 120, and the second region 122 may be formed on a side surface 120c connecting the first and second surfaces 120a and 120b to each other. In some embodiments, the electrode assembly 110 may entirely have a shape in which the first region 121 surrounds the lower surface of the electrode assembly 110 and the second region 122 surrounds the side surface of the electrode assembly 110. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer. In some embodiments, the side surface may be an outside surface.

In some embodiments, the first region 121 may be implemented to have a plate shape including metal. In some embodiments, the case 120 may radiate heat through the second surface 120b, using a water or air cooling method. In embodiments where the first region 121 includes metal, the dissipation function of the battery cell 100a can be improved. Therefore, the first region 121 may include metal having excellent dissipation performance, e.g., aluminum or magnesium.

In the case where the first region 121 includes the metal, the first region 121 may be short-circuited with the electrode assembly 110. Therefore, an insulation sheet 123 may be further included in the first region 121. Specifically, the insulation sheet 123 may be positioned on the inner surface of the first region 121 opposite to the electrode assembly 110, and accordingly, it is possible to prevent the electrode assembly 110 from being short-circuited with the first region 121. Thus, the safety of the battery cell 100a can be improved.

In some embodiments, the second region 122 may have a shape extended long in a state in which the inside of the second region 122 is empty so as to accommodate the electrode assembly 110. In some embodiments, the second region 122 may include a resin, plastic or hot melt material. In some embodiments, the second region 122 may be manufactured through injection molding. Since the second region 122 of the case 120 is manufactured through the injection molding, the manufacturing process can be simplified as compared with the existing case where metal is processed through the more complicated process of deep drawing or pressing. In some embodiments, the first region 121 including the metal is positioned on the second surface 120b, and the second region 122 including the resin is positioned on the side surface 120c, so that it is possible to simplify the manufacturing process of the battery cell 100a while improving the dissipation function of the battery cell 100a. Further, the weight of the battery cell 100a can be decreased as compared with a case where the entire case 120 is made of metal. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

In some embodiments, the outermost surface of the portion at which the first and second regions 121 and 122 are connected to each other may form the same plane with the second region 122 of the case 120, i.e., the side surface 120c of the case 120. This is because the dimensions of the external shape of the battery cell 100a are limited. In this embodiment, this can be implemented by placing the outer end of the first region 121 inside the second region 122. In some embodiments, the first and second regions 121 and 122 may be manufactured through insert-injection molding (the second region 122 is formed by putting the first region 121 in a mold and injection-molding resin). Accordingly, the coherence between the first and second regions 121 and 122 can be improved. In some embodiments, the second region 122 may be thermally compressed with the first region 121 since the second region 122 is made of the resin. Conventionally, both the first and second regions made of metal may be connected through welding. However, in this embodiment, the first and second regions 121 and 122 are connected through thermal compression or insert-injection molding, so that it is possible to prevent the leakage phenomenon caused by the existing welding process. Further, it is possible to reduce cost for high-priced welding equipment. In the battery cell 100a according to this embodiment, the coherence between the first and second regions 121 and 122 is relatively strong, and thus it is possible to prevent the safety of the battery cell 100a from being lowered due to the inflow of moisture or outflow of the electrolyte. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

In some embodiments, the top portion 130 may be a member positioned on the opened first surface 120a of the case 120 in an assembled state.

In some embodiments, the top portion 130 may form one surface of the case 120 by sealing the first surface 120a of the case 120. In some embodiments, the top portion 130 may be made of resin. Like the second region 122 of the case 120, the top portion 130 may be manufactured through injection molding. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

For example, the top portion 130 may be thermally bonded or compressed to the second region 122 of the case 120. Thus, it is possible to reduce the leakage phenomenon that occurs when the existing cap assembly made of metal is laser-welded to the case. In some embodiments, the top portion 130 and the second region 120 may be coupled to each other through thermal bonding or compression. Accordingly, the manufacturing process is simpler than the existing welding process, and the manufacturing cost and manufacturing time can be reduced. The bonding between the top portion 130 and the second region 122 is strong, and thus it is possible to prevent the outflow of the electrolyte or the inflow of the moisture between the top portion 130 and the second region 122.

In some embodiments, the top portion 130 may be made of an insulation material such as resin, and thus the configuration of the top portion 130 can be simplified as compared with the existing cap assembly. In some embodiments, the existing cap assembly corresponding to the top portion 130 includes a cap plate, a terminal plate, a gasket and the like so as to prevent a short circuit with the electrode assembly. Therefore, the configuration of the existing cap assembly is complicated. However, the battery cell 100a according to this embodiment has the top portion 130, and thus it is possible to simplify the structure sealing the first surface 120a of the case 120 (the structure of the existing cap assembly). Further, since the top portion 130 is made of resin, the top portion 130 is hardly deformed by the electrolyte, and there is no concern that the top portion 130 will form a short-circuit with the electrode assembly 110. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

In some embodiments, the top portion 130 may be provided with a terminal hole 131 through which the terminal portion 140 passes, an electrolyte injection hole through which the electrolyte is injected, a vent opened under a predetermined pressure, and the like.

The terminal portion 140 is a member extended toward the outside from the top portion 130. In some embodiments, the terminal portion 140 can transfer electrochemical energy generated in the battery cell 100a to the outside of the battery cell 100a.

In some embodiments, one end of the terminal portion 140 may be connected to the electrode assembly 110, and the other end of the terminal portion 140 may be exposed to the outside by passing through the terminal hole 131 of the top portion 130. In some embodiments, the terminal portion 140 may include a positive electrode terminal portion 141 and a negative electrode terminal portion 142. In some embodiments, the positive electrode terminal portion 141 may be connected to the positive electrode plate 111 of the electrode assembly 110, and the negative electrode terminal portion 142 may be connected to the negative electrode plate 113 of the electrode assembly 110. In some embodiments, the positive and negative electrode terminal portions 141 and 142 are spaced apart from each other at a predetermined distance, so as to be electrically insulated from each other.

In some embodiments, the terminal portion 140 may be configured so that the terminal hole 131 is separately formed in the top portion 130 and the top portion 140 then passes through the terminal hole 131. However, the terminal portion 140 may be configured so that the top portion 130 and the terminal portion 140 are coupled to each other by insert-injection molding the terminal portion together with the top portion 130. In the insert-injection molding, the top portion 130 and the terminal portion 140 can be adhered closely to each other. Thus, there is no concern that the internal electrolyte is flowed out from the battery cell 100a or the external moisture is penetrated into the battery cell 100a. Further, it is unnecessary to form the separate terminal hole 131, thereby simplifying the manufacturing process of the battery cell 100a.

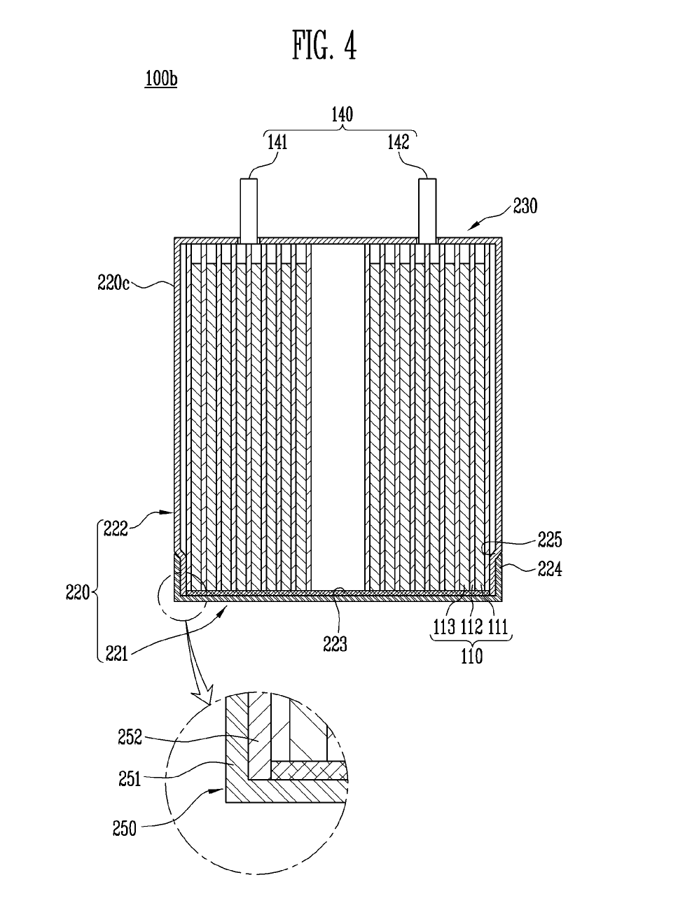

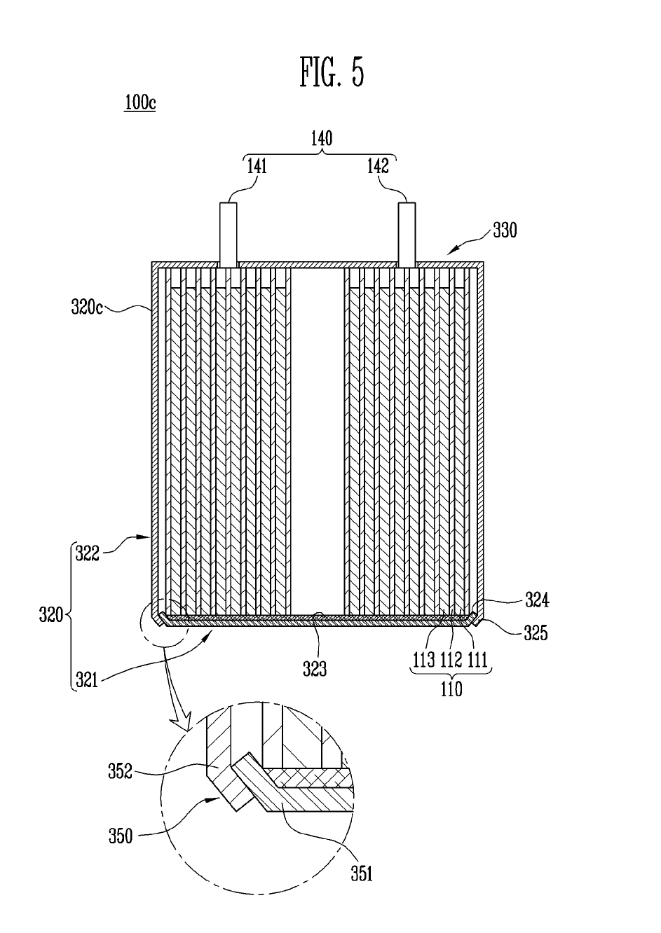

FIGS. 4 and 5 are sectional views of battery cells 100b and 100c according to other embodiments. Hereinafter, embodiments of the battery cells 100b and 100c will be described with reference to FIGS. 4 and 5. In these embodiments, components identical or corresponding to those of the aforementioned embodiment are designated by like reference numerals, and their detailed descriptions will be omitted to avoid redundancy.

As shown in FIGS. 4 and 5, some embodiments of the battery cell 100b or 100c provide, a top portion 230 or 330 and a second region 222 or 322 of a case 220 or 320 may be formed in a single body, and a first region 221 or 321 may be entirely or partially anodized. In some embodiments, the first region 221 and the second region 222 include a connection region 250 (see FIG. 4). In some embodiments, the first region 321 and the second region 322 include a connection region 350 (see FIG. 5). In some embodiments, the portion at which the first region 221 or 321 and the second region 222 or 322 meet each other may be bent. In some embodiments, the connection region 250 includes a first overlapping segment 252 and a second overlapping segment 251, wherein the first overlapping segment 252 has a first surface and a second surface, and the second overlapping segment 251 has a first surface and a second surface (see FIG. 4). In some embodiments, the connection region 350 includes a first overlapping segment 352 and a second overlapping segment 351, wherein the first overlapping segment 352 has a first surface and a second surface, and the second overlapping segment 351 has a first surface and a second surface (see FIG. 5).

In some embodiments, the top portion 230 or 330 and the second region 222 or 322 of the case 220 or 320 may be integrally manufactured, for example, through an injection molding process. Thus, it is possible to omit a process of thermally bonding the top portion 230 or 330 to the second region 222 or 322 of the case 220 or 320 and to reduce process time and cost. When the top portion 230 or 330 and the second region 222 or 322 are injection-molded, the terminal portion 140 is insert-injection molded, so that the top portion 230 or 330, the second region 222 or 322 and the terminal portion 140 can be manufactured as one set.

In some embodiments, the first region 221 or 321 may be anodized in order to prevent the first region 221 or 321 from being short-circuited with the electrode assembly 110.

Specifically, in a case where the first region 221 or 321 includes aluminum, the first region 221 or 321 may be connected to a positive electrode of a DC power source and then immersed in an acid solution (electrolytic solution), thereby forming an anodized layer 223 or 323 made of alumina on the surface of the first region 221 or 321. More specifically, the surface of the first region 221 or 321 reacts with the electrolytic solution (acid solution), and therefore, aluminum ions (Al³⁺) are formed at the boundary surface between the electrolytic solution and the surface of the first region 221 or 321. The current density may be concentrated on the surface of the first region 221 or 321 by the voltage applied to the first region 221 or 321, thereby generating localized heat to the region. Therefore, a large quantity of aluminum ions may be formed. As a result, a plurality of grooves may be formed on the surface of the first region 221 or 321, and oxygen ions (e.g. O²⁻) may react with the aluminum ions by being moved to the grooves by means of an electric field. Accordingly, the anodized layer 223 or 323 configured with an alumina layer can be formed.

In some embodiments, the anodized layer 223 or 323 formed on the first region 221 or 321 is used to prevent a short circuit with the electrode assembly 110. Therefore, the anodized layer 223 or 323 is preferably formed on the inner surface of both surfaces of the first region 221 or 321, which is opposite to the electrode assembly 110. In embodiments where the anodized layer 223 or 323 may be formed on the first region 221 or 321, the anodized layer 223 or 323 may have a large dissipation effect as compared with the insulation sheet made of resin or the like. Thus, the dissipation effect of the battery cell 100b or 100c can be further improved.

In some embodiments, at least one of a first connection portion 224 or 324 of the first region 221 or 321 and a second connection portion 225 or 325 of the second region 222 or 322 may be bent. In some embodiments, the first region 221 or 321 and the second region 222 or 322 may be connected to each other by the first connection portion 224 or 324 and the second connection portion 225 or 325.

This is for the purpose that the adhesion area between the first region 221 or 321 and the second region 222 or 322 is increased, thereby maximizing the bonding between the first region 221 or 321 and the second region 222 or 322. Specifically, since the first region 221 or 321 may be made of metal and the second region 222 or 322 may be made of resin, the bonding between the first region 221 or 321 and the second region 222 or 322 may be weak. However, in this embodiment, the connection portion 224 or 324 of the first region 221 or 321 and the connection portion 225 or 325 of the second region 222 or 322 may be bent, thereby improving the bonding area and hence the strength of the bond between the first region 221 or 321 and the second region 222 or 322. In some embodiments, the resin may be at least one selected from the group consisting of acrylonitrile butadiene styrene polymer, polyoxymethylene, high density polyethylene, low density polyethylene, polyethylene terephthalate, polyvinyl chloride, polypropylene, polystyrene, fluorine treated high density polyethylene, and styrene-butadiene copolymer.

For example, as shown in FIG. 4, the second connection portion 225 of the second region 222 may be bent toward the inside of the first connection portion 224 in configurations in which the first connection portion 224 of the first region 221 is not modified. However, the present embodiments are not limited thereto, and both the first and second connection portions 324 and 325 may be angled as shown in FIG. 5. In some embodiments, the first connection portion 224 or 324 of the first region 121 or 221 may be bent toward the inside of the second connection portion 225 or 325 in a state in which the second connection portion 225 or 325 is not modified. When considering dimensions of the battery cell 100b or 100c, the outermost surface of the portion at which the first and second regions 221 and 222 are connected to each other (the portion at which the first and second connection portions 224 and 225 are connected to each other) preferably forms the same plane as the second region 222, i.e., a side surface 220c of the case 220 (see FIG. 4), or the outermost surface of the portion at which the first and second regions 321 and 322 are connected to each and angled inward from a side surface 320c of the case 320 (see FIG. 5). In some embodiments, the outside surface of the side 220c comprises the first surface of the first overlapping segment 251 (see FIG. 4). In some embodiments, the second surface of the first overlapping segment 251 is disposed on the first surface of the second overlapping segment 252 (see FIG. 4). In some embodiments, the outside surface of the side 320c comprises the first surface of the second overlapping segment 352 (see FIG. 5). In some embodiments, the second surface of the second overlapping segment 352 is disposed on the first surface of the first overlapping segment 351 (see FIG. 5).

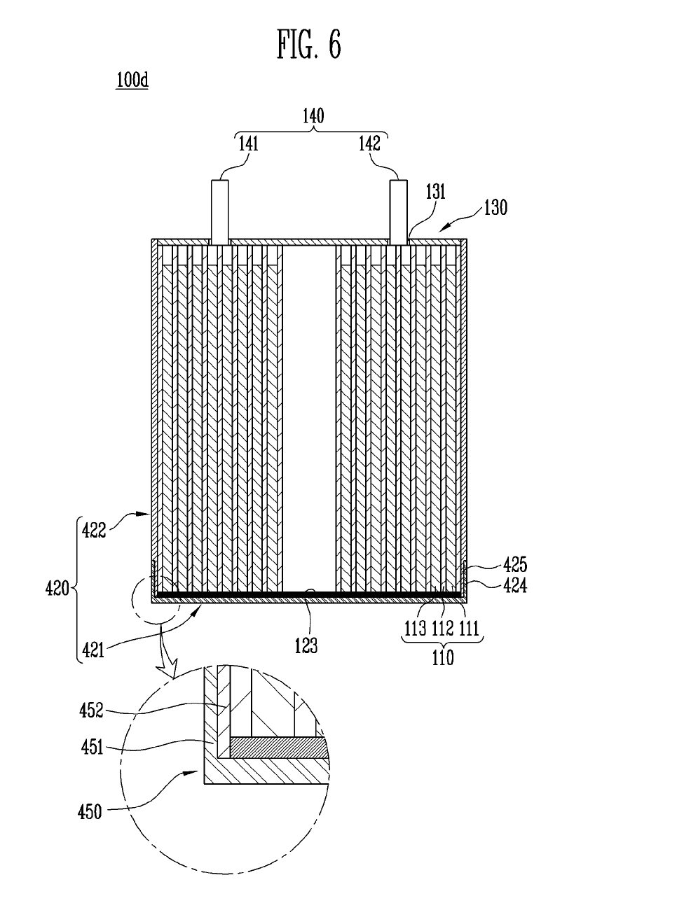

FIG. 6 is a sectional view of a battery cell 100d according to still another embodiment. Hereinafter, the connection relationship between first and second regions 421 and 422 of a case 420 according to this embodiment will be described with reference to FIG.

6.

As shown in FIG. 6, a first connection portion 424 of the first region 421 or a second connection portion 425 of the second region 422 may be formed in a stepped configuration. In this case, the stepped directions of the first and second connection portions 424 and 425 may be opposite to each other. Accordingly, if the first and second connection portions 424 and 425 are connected to each other, both surfaces of the connected portion may form the same plane as the respective outer and inner surfaces of the second region 422. In some embodiments, the first region 421 and the second region 422 include a connection region 450.

In a case where the first and second connection portions 424 and 425 are formed to be stepped, the surface of the connection portion is not protruded in any direction of the inside and the outside of the second region 422. Thus, it is further advantageous to control the dimension and capacity of the battery cell 100d, thereby miniaturizing the battery cell 100d. In some embodiments, the outside surface of the side first region 421 and the second region 422 include a connection region 450. In some embodiments, the connection region 450 includes a first overlapping segment 452 and a second overlapping segment 451, wherein the first overlapping segment 452 has a first surface and a second surface, and the second overlapping segment 451 has a first surface and a second surface. In some embodiments, the first surface of the first overlapping segment 452 is disposed on the second surface of the second overlapping segment 451 where the first overlapping segment 452 and the second overlapping segment 451 are formed to be stepped. In some embodiments, the outside surface of the side does not comprise the first overlapping segment 452.

While the present embodiments have been described in connection with certain exemplary embodiments, it is to be understood that the invention is not limited to the disclosed embodiments and is intended to cover various modifications and equivalent arrangements included within the spirit and scope of the appended claims, and equivalents thereof. Therefore, the aforementioned embodiments should be understood to be exemplary but not limiting this disclosure in any way.

What is claimed is:

1. A battery cell, comprising:
a case having a top portion, a side and a bottom; and
an electrode assembly accommodated inside the case,
wherein the top portion includes a first surface through which a terminal portion extended from the electrode assembly is exposed, wherein the first surface and bottom are each separately connected to the side, wherein the side has an outside surface and an inside surface, and
wherein the case has at least one region including resin.

2. The battery cells of claim 1, wherein the top portion includes resin.

3. The battery cells of claim 1, wherein the case includes:
a first region; and
a second region contacting the first region, wherein the second region comprises a portion of the side, wherein the first region comprises the bottom, and
wherein the second region includes resin.

4. The battery cells of claim 3, wherein the top portion and the second region are formed in a single body.

5. The battery cells of claim 3, wherein the top portion and the second region are thermally bonded to each other.

6. The battery cells of claim 3, wherein the first region includes metal.

7. The battery cells of claim 6, wherein the first region includes aluminum or magnesium.

8. The battery cells of claim 6, wherein the inner surface of the first region opposite to the electrode assembly is anodized.

9. The battery cells of claim 6, further comprising an insulation sheet positioned on the inner surface of the first region opposite to the electrode assembly.

10. The battery cells of claim 3, wherein the top portion and the second region of the case are injection-molded.

11. The battery cells of claim 3, wherein at least one of a first connection portion of the first region and a second connection portion of the second region, by which the first and second regions are connected to each other, is bent.

12. The battery cells of claim 3, wherein at least one of a first connection portion of the first region and a second connection portion of the second region, by which the first and second regions are connected to each other, is formed in a stepped configuration.

13. The battery cells of claim 3, wherein the outermost surface of the portion at which the first and second regions are connected to each other forms the same plane as the outer surface of the second region.

14. The battery cells of claim 3, wherein the outermost surface of the portion at which the first and second regions are connected to each other enters further inward than the outer surface of the second region.

15. The battery cells of claim 3, wherein the first region and the second region comprise a connection region.

16. The battery cells of claim 15, wherein the connection region comprises a first overlapping segment and a second overlapping segment, wherein the first overlapping segment has a first surface and a second surface, and the second overlapping segment has a first surface and a second surface.

17. The battery cells of claim 16, wherein the outside surface of the side comprises the first surface of the first overlapping segment.

18. The battery cells of claim 17, wherein the second surface of the first overlapping segment is on the first surface of the second overlapping segment.

19. The battery cells of claim 16, wherein the second surface of the second overlapping segment is on the first surface of the first overlapping segment.

20. The battery cells of claim 19, wherein the outside surface of the side does not comprise the first overlapping segment.
